(19) United States
(12) Patent Application Publication
(10) Pub. No.: US 2010/0226505 A1
(43) Pub. Date: Sep. 9, 2010

(54) NOISE CANCELING HEADPHONE

(76) Inventor: Tominori Kimura, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/681,639

(22) PCT Filed: Sep. 11, 2008
(86) PCT No.: PCT/JP2008/066893

§ 371 Date: Apr. 5, 2010

(30) Foreign Application Priority Data
Oct. 10, 2007 (JP) 2007-264423

(51) Int. Cl. G10K 11/16

(52) U.S. Cl. 381/71.6

(57) ABSTRACT

A noise canceling headphone includes; a microphone that converts an ambient noise into an electrical signal; a canceling signal generating unit that generates a canceling signal by inverting a phase of a noise signal obtained by the conversion in the microphone; and a speaker that mixes and outputs an audio signal and the canceling signal. The noise canceling headphone further includes: a standard signal generating unit that generates a standard signal of a certain level; and a comparing unit that outputs a control signal according to a result of comparing the noise signal with the standard signal. The canceling signal generating unit starts operating with the control signal output from the comparing unit. With the noise canceling headphone, a noise canceling headphone can be obtained in which whether the canceling process is required is controlled according to a level of an ambient noise.

### TECHNICAL FIELD

The present invention relates to a noise canceling headphone that outputs a signal that cancels an ambient noise together with music so that the noise can be canceled out and only the music can be listened to, and more specifically, to a noise canceling headphone that allows a canceling process corresponding to a level of an ambient noise.

### BACKGROUND ART

Widespread use of portable music players of a various kind has entailed demands for headphones with higher performances to be used therewith. In addition, a noise canceling headphone is also demanded with which only music can be listened to without being interfered by an ambient unwanted sound (noise) upon listening to music in the street or while on a vehicle.

In fact, in an environment with a noise, the noise enters an ear along with a reproduced sound of music. Thus, even if the music reproduced from a headphone has high sound quality, the music of a high sound quality cannot be enjoyed due to an effect of the noise. In addition, a volume level of reproduced music tends to be set high due to the effect of the ambient noise leading to a leakage of sound from the headphone, and the leaked sound ends up as a noise source that makes the surrounding people uncomfortable on a vehicle for example. Because of such background, noise canceling headphones are gaining popularity.

A noise canceling headphone: collects an ambient noise, which serves as an input signal, with a sound collecting microphone mounted on, for example, a headphone casing; generates a signal having a phase opposite from that of the input signal; and outputs, from a speaker unit included in the headphone, the generated opposite phase signal (canceling signal) together with music. Thus, the ambient noise is cancelled out with the canceling signal output from the speaker unit so that only the music can be listened to.

As described above, a noise canceling headphone generates a canceling signal from an ambient noise collected with a sound collecting microphone. Therefore, even if the ambient noise is a sound for informing a surrounding situation (e.g., a siren or a horn, which hereinafter will be referred to as a “surrounding situation sound”), a canceling signal for canceling out the sound is generated and output. Canceling out such a surrounding situation sound hampers a safe use of a noise canceling headphone. Accordingly, a noise canceling headphone that can be safely used by a user is known that selectively separates a “sound interesting for a user” in surrounding situation sounds included in a noise, so as not to generate a canceling signal for the “sound interesting for a user”, but generates a canceling signals for other sounds (see, for example, Patent Document 1).

### [Patent Document 1] Japanese Patent Application Laid-Open No. 2004-526375

### DISCLOSURE OF THE INVENTION

### Problem to be Solved by the Invention

The noise canceling headphone disclosed in the document has a noise canceling circuit that keeps operating even in an environment where an ambient noise is small enough to require no noise canceling process and thus a noise canceling signal is generated and output for a slight noise input. Unfortunately, affected by the canceling signal, the sound quality of the music output from a speaker unit may be slightly changed. Besides, in an environment with a sufficiently small ambient noise, an internal noise from the noise canceling circuit itself (a noise output from, for example, a headphone amplifier) may be louder than the ambient noise. In this case, the canceling signal itself can be the noise that adversely affects the sound quality. In addition, a noise canceling circuit generally uses a battery as a driving power source. Thus, an unnecessary noise canceling process consumes the battery more than necessary to hamper maintaining of the noise canceling process for a long period of time.

An object of the present invention is to provide a noise canceling headphone offering high sound quality that can be driven for a long period of time, in which a canceling signal generating process is automatically controlled by comparing a level of a standard signal that can be arbitrarily set by a user with a level of an ambient noise, and the process is stopped with a noise of a level requiring no canceling process so as to be used as a regular headphone.

### Means for Solving the Problem

The present invention is a noise canceling headphone including: a microphone that converts an ambient noise into an electrical signal; a canceling signal generating unit that generates a canceling signal by inverting a phase of a noise signal obtained by the conversion in the microphone; and a speaker that mixes and outputs an audio signal and the canceling signal. The noise canceling headphone further includes: a standard signal generating unit that determines a level of a standard signal; and a comparing unit that outputs a result of comparing the noise signal with the standard signal. The canceling signal generating unit starts operating With the output from the comparing unit.

Further, the present invention is a noise canceling headphone including: a microphone that converts an ambient noise into an electrical signal; a canceling signal generating unit that generates a canceling signal by inverting a phase of a noise signal obtained by the conversion in the microphone; and a speaker that mixes and outputs an audio signal and the canceling signal. The noise canceling headphone further includes: a standard signal generating. unit that generates a standard signal corresponding to the noise signal; and a comparing unit that outputs a result of comparing the noise signal with the standard signal. The comparing unit stops the operation of the canceling signal generation unit with the output from the comparing unit.

The present invention further includes a standard level adjusting unit that adjusts a generation level of the standard signal.

### Effects of the Invention

With the present invention, in a noise canceling headphone, a noise canceling process is stopped in the case in which a level of a collected ambient noise is low, and the noise canceling process is only implemented in the case in which a level of a collected ambient noise is high. Thus, the noise canceling process can be operated for a long period of time without degrading the sound quality of music.

In addition, because a noise from inside of a noise canceling circuit can be prevented from being output, music of a high quality sound can be enjoyed.

### BRIEF DESCRIPTION OF THE DRAWINGS

FIG. 1 is a cross sectional external view partially depicting an embodiment of a noise canceling headphone according to the present invention.

FIG. 2 is a block diagram depicting an example of a noise canceling circuit included in the noise canceling headphone.

FIG. 3 is a flow chart depicting an example of a noise canceling process performed by the headphone.

FIG. 4 is a flow chart depicting another example of a noise canceling process performed by the headphone.

FIG. 5 is a block diagram depicting another example of a noise canceling circuit included in the noise canceling headphone according to the present invention.

FIG. 6 is a flow chart depicting still another example of a noise canceling process performed by the headphone.

FIG. 7 is a flow chart depicting yet still another example of a noise canceling process performed by the headphone.

FIG. 8 is a block diagram depicting an example of a muting circuit included in the noise canceling headphone.

### EXPLANATIONS OF LETTERS OR NUMERALS

10 canceling signal generating device
18 comparing circuit
19 headphone amplifier
20 standard signal generating circuit
21 standard adjusting circuit
22 muting circuit
30 microphone unit
40 switch
50 mixer
60 speaker unit

### BEST MODE(S) FOR CARRYING OUT THE INVENTION

A noise canceling headphone according to the present invention is described below with reference to the drawings.

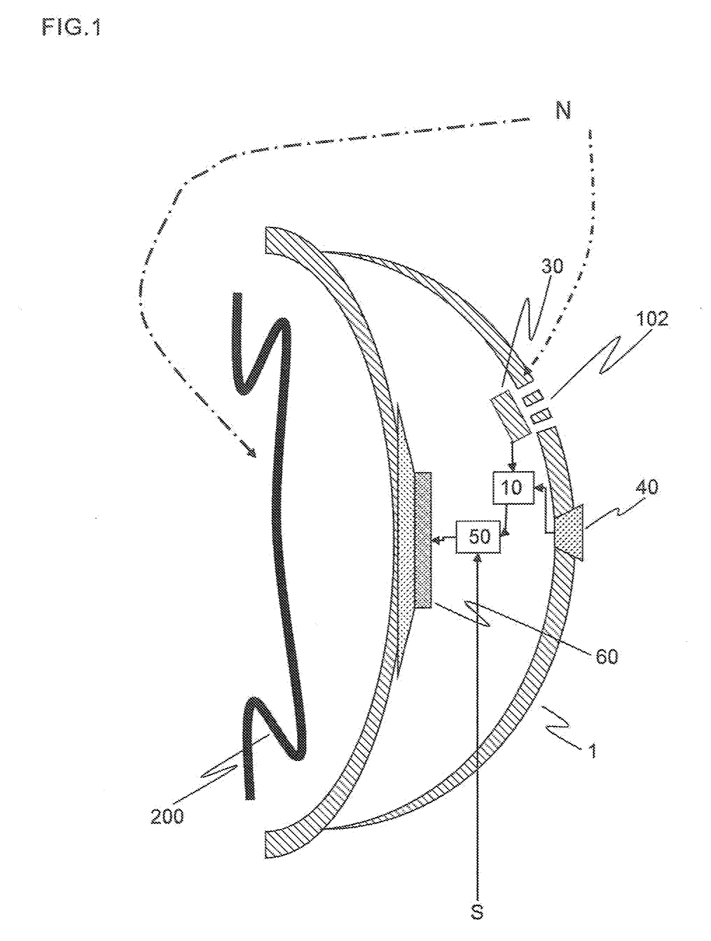

FIG. 1 is a schematic depicting only one of a pair of noise canceling headphone casings. In FIG. 1, a headphone unit 1 includes: a canceling signal generating device (hereinafter, referred to as an “NC”) 10 having a DSP (digital signal processor) that generates a canceling signal as a main component; a microphone unit 30 installed to be directed toward the outside of the headphone unit 1 so as to collect a noise N around a user of the noise canceling headphone; through holes 102 provided at a part of the headphone unit 1; a switch 40 for selecting a level of a standard signal used for determining whether the NC 10 is to be operated; a mixer 50 that synthesizes and outputs an output from the NC 10 and a music signal S; and a speaker unit 60 that outputs an output from the mixer 50 (a synthesized signal of the music signal S and a canceling signal) to a user's ear 200. A battery, which is not shown in the figure, serving as a driving power source for the NC 10 is also included in the headphone unit 1. The music signal S is input from, for example, a portable music player, which is not shown in the figure.

As shown in FIG. 1, a noise N collected by the microphone unit 30 is input to the NC 10, so that a canceling signal is generated and output from the speaker unit 60. With the switch 40, the level of the standard signal used to determine whether the canceling signal generation process is required can be switched. The mixer 50 synthesizes the music signal S with the canceling signal, i.e., the output from the NC 10, and outputs the resultant signal to the speaker unit 60. By outputting a sound from the music signal S together with the canceling signal from the speaker unit 60 as described above, because the noise N and the canceling signal cancel out with each other, only the sound from the music signal S is delivered to the ear 200.

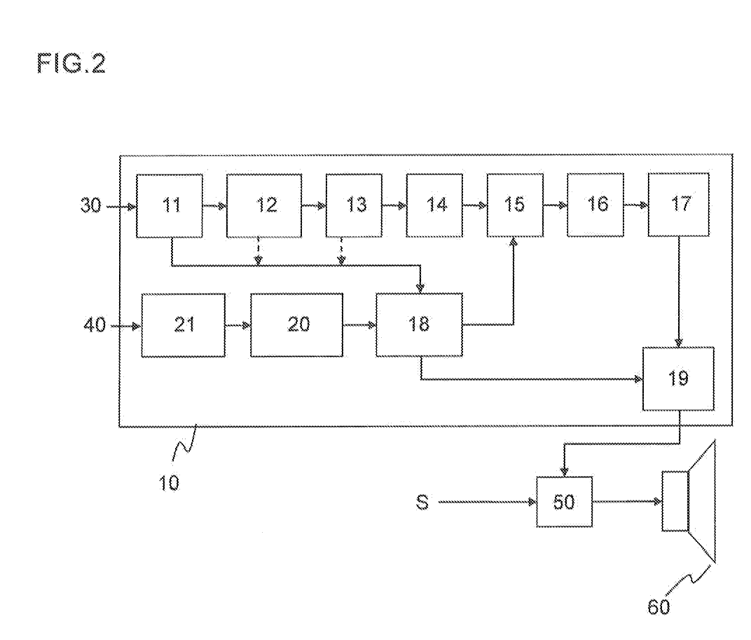

The NC 10 is described in detail below with reference to a block diagram of FIG. 2. In FIG. 2, the NC 10 includes: a microphone amplifier 11 that amplifies a noise N, collected by the microphone unit 30, to a certain level; a phase adjuster 12 that adjusts a phase of the amplified noise N; a low-pass filter (LPF) 13 that eliminates a high-frequency component of the noise N; an A/D 14 that converts the noise N into a digital signal; a DSP 15 that generates a canceling signal for the noise N converted into a digital signal; a D/A 16 that converts the canceling signal generated by the DSP 15 into an analog signal; a post filter 17 that smoothes the canceling signal converted into an analog signal; a headphone amplifier 19 for driving the speaker unit 60; a comparing circuit 18 that determines the level of the noise N output from the microphone amplifier 11; a standard signal generating circuit 20 that generates a standard signal indicating a standard, which is used by the comparing circuit 18; and a standard adjusting circuit 21 with which the user can arbitrarily switch the level of the standard signal by means of the switch 40 installed on an outer wall surface of the casing of the headphone unit 1.

Because the comparing circuit 18 is required to determine the level of the noise N, not only the output from the microphone amplifier 11, but also the output from the phase adjusting circuit 12 or the LPF 13 maybe input thereto.

The comparing circuit 18 compares the level of the noise N with the level of the standard signal generated by the standard signal generating circuit 20, and if the level of the noise N is lower than the level of the standard signal, a control signal is output to the DSP 15 and the headphone amplifier 19 to instruct the operation thereof to be stopped. The comparing circuit 18 compares the level of the noise N with the level of the standard signal, and if the level of the noise N is higher than the level of the standard signal, a control signal is output to the DSP 15 and the headphone amplifier 19 to instruct the operations thereof to be started.

The canceling signal output via the headphone amplifier 19 is synthesized with the music signal S in the mixer 50 and is output from the speaker unit 60.

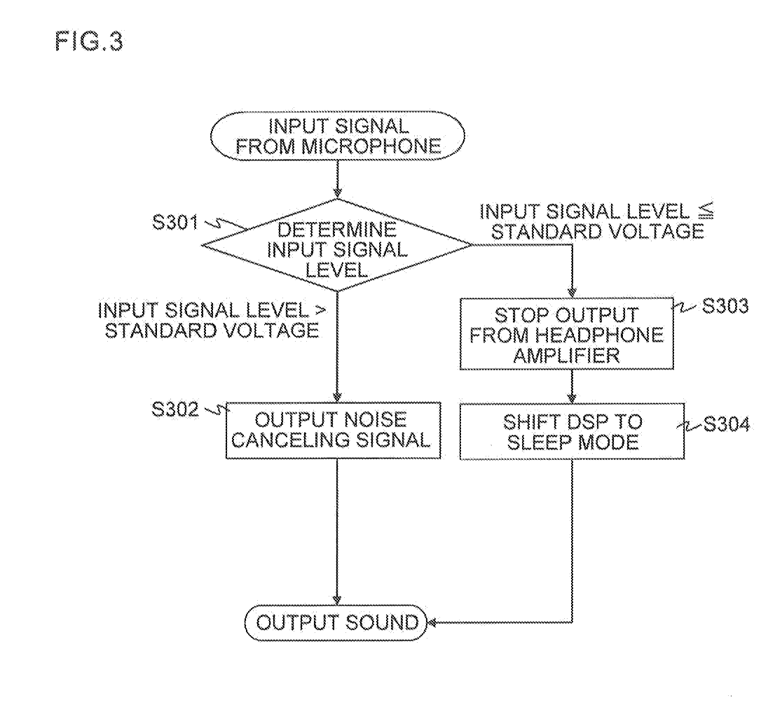

An example of an operation of the NC 10 is described below with reference to a flowchart of FIG. 3.

The noise canceling headphone according to the present invention has: a mode in which a noise canceling circuit starts operating upon power activation; and a mode in which a noise canceling circuit starts operating not upon power activation but starts operating according to a level of a noise input from the microphone unit 1. FIG. 3 depicts a flow of an operation in the mode in which the noise canceling circuit is operated upon power activation.

First, a noise N input from the microphone unit 30 is amplified to a certain level with the microphone amplifier 11 and then is input to the comparing circuit 18 so that the level of the noise N and the level of the standard signal generated by the standard signal circuit 20 are compared (S301). In the case in which the level of the noise N is high, the comparing circuit 18 outputs no control signal so that the NC 10 keeps operating. Therefore, the DSP 15 generates a canceling signal corresponding to the noise N. The canceling signal is output to the mixer 50 via the headphone amplifier 19 to be synthesized with the sound signal S and then is output from the speaker unit 60 (S302).

If the comparing circuit 18 has determined that the level of the noise N input from the microphone unit 30 is lower than the level of the standard signal, the comparing circuit 18 outputs the control signal to the headphone amplifier 19 to instruct the operation thereof to be stopped (S303). Thus, the headphone amplifier 19 stops the output operation to the speaker unit 60.

Then, the comparing circuit 18 outputs the control signal to the DSP 15 to instruct the operation thereof to be stopped (S304). Thus, the DSP 15 stops the canceling signal generating process. As described above, in the case in which the noise N of a level lower than the level of the standard signal, no noise canceling process is performed and output to the headphone amplifier is stopped. Thus, other signals such as an amplifier noise different from the canceling signal are not output from the speaker unit 60 and no change in sound quality is caused by the signal processing performed by the noise canceling headphone.

More specifically, in the case in which the level of the noise N is lower than the level of the standard signal, it is possible to output only a sound from the music signal S.

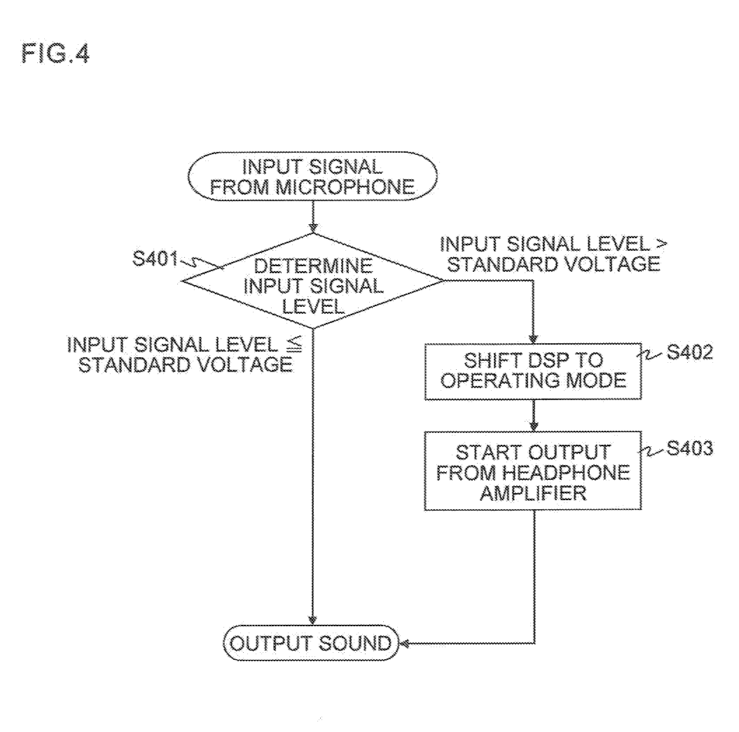

Another operation of the NC 10 is described below. FIG. 4 depicts a flow of an operation in the mode in which the noise canceling circuit starts operating not upon power activation but starts operating according to a level of a noise input from the microphone unit 1.

First, a noise N input from the microphone unit 30 is amplified to a certain level with the microphone amplifier 11 and then is input to the comparing circuit 18 so that the noise N is compared with the level of the standard signal generated by the standard signal circuit 20 (S401). In the case in which the level of the noise N is low, nothing is output from the comparing circuit 18 so that the DSP 15 and the headphone amplifier 19 do not operate and nothing is output from the NC 10 to the mixer 50.

In the case in which the level of the noise N is higher than the level of the standard signal, the comparing circuit 18 outputs the control signal to the DSP 15 to instruct the operating mode to be changed (S402). Thus, the DSP 15 starts the generation operation of a canceling signal for an input noise N.

Then, the comparing circuit 18 outputs the control signal to the headphone amplifier 19 to instruct the operation thereof to be started (S403). Thus, the generated canceling signal is output to the mixer 50. The music signal S is synthesized with the canceling signal and then is output to the speaker unit 60 so that a sound from the music signal S together with the canceling signal is output from the speaker unit 60.

Another embodiment of a noise canceling signal generation device (NC) that can be used in the noise canceling headphone according to the present invention is described below.

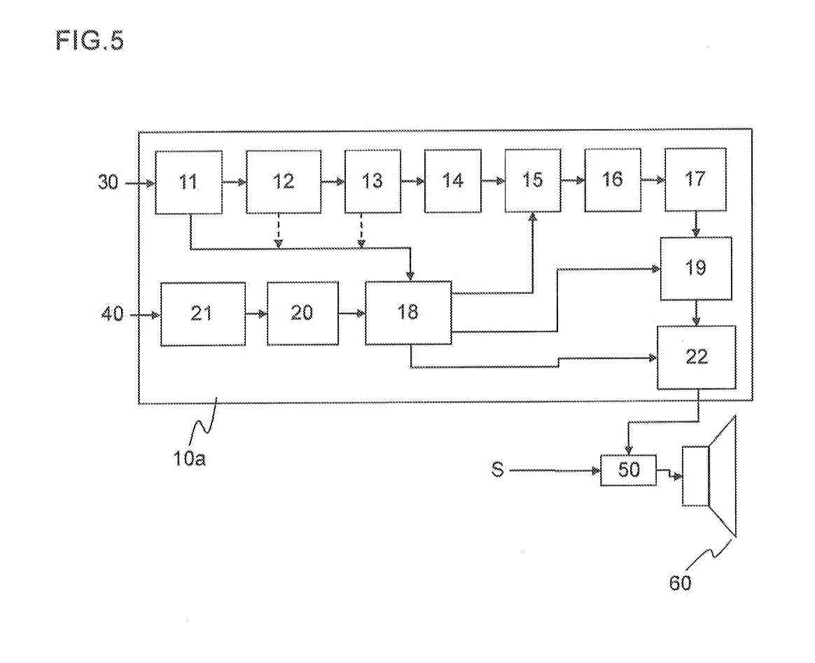

FIG. 5 depicts a detail of an NC 10a according to this embodiment. The NC 10a has a configuration in which a muting circuit 22 is added to the above described NC 10. Therefore, the same components as those in the above described NC 10 are given the same reference numerals and the description thereof is omitted.

The muting circuit 22 electrically disconnects the headphone amplifier 19 from the speaker unit 60 in the case in which a noise N is smaller than the level of the standard signal. Upon determining that the level of the noise N is lower than the standard signal as a result of comparing the level of the noise N and the level of the standard signal generated by the standard signal circuit 21, the comparing circuit 18 outputs: the control signal to the. DSP 15 and the headphone amplifier 19 to instruct the operation thereof to be stopped; and also a control signal to the muting circuit 22 to instruct the operation thereof to be started. Thus, the muting circuit 22 electrically disconnects the headphone amplifier 19 from the speaker unit 60 so that the NC 10 and the mixer 50 are electrically separated.

With the muting circuit 22 performing such operation, no internal noise from the NC 10a is output from the speaker unit 60. Thus, it is possible to output only a high quality sound from the music signal S.

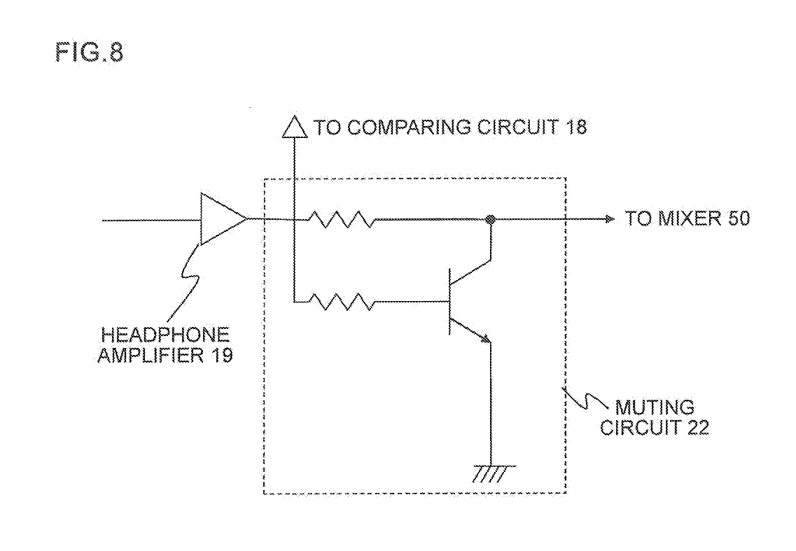

An example of a circuit structure of the muting circuit 22 is shown in FIG. 8. As shown in FIG. 8, an output terminal of the headphone amplifier 19 is connected to the mixer 50 via the muting circuit 22. The muting circuit is formed with a transistor and upon receiving. the control signal from the comparing circuit 18 through a base terminal thereof, a collector terminal connected to an output terminal of the headphone amplifier 19 and a grounded emitter terminal are short circuited. Thus, an output from the headphone amplifier 19 is grounded so as not to be output to the mixer 50. Therefore, providing the muting circuit 22 prevents an internal noise peculiar to the amplifier circuit to be output from the speaker unit 60.

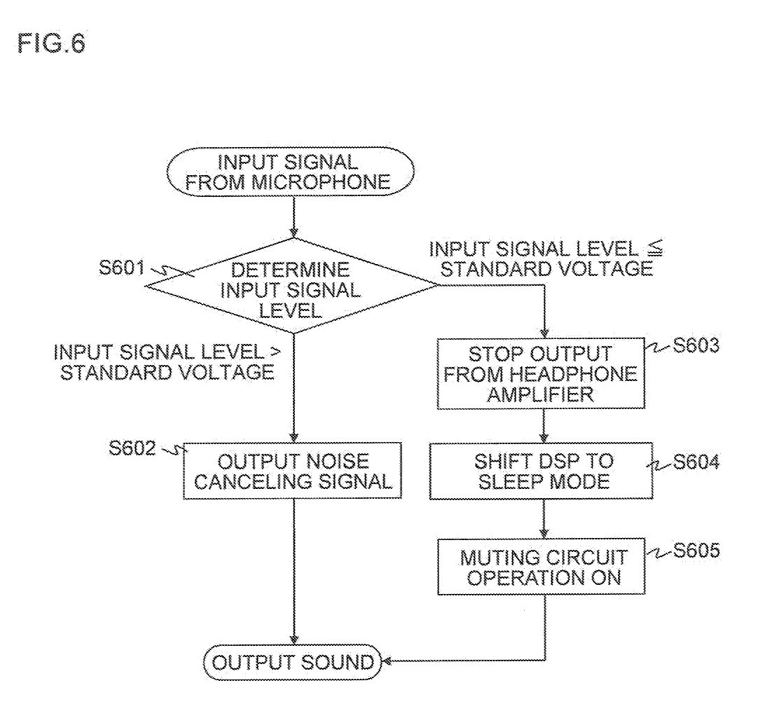

Next, with reference to a flowchart of FIG. 6, the flow of the operation of the NC 10a will be described. As described above, the noise canceling headphone according to the present invention has: the mode in which the noise canceling circuit starts operating upon power activation; and the mode in which the noise canceling circuit is not operated upon power activation but starts the operation with an input from the microphone unit 1. The present embodiment is an example of the mode in which the noise canceling circuit is operated with power activation.

First, a noise N input from the microphone unit 30 and amplified to a certain level with the microphone amplifier 11 is input to the comparing circuit 18 so that the level of the noise N and a level of a standard signal generated by the standard signal circuit 20 are compared (S601), In the case in which the level of the noise N is high, nothing is output from the comparing circuit 18 and a canceling signal corresponding to the noise N is generated in the DSP 15. The canceling signal is output to the mixer 50 via the headphone amplifier 19 to be synthesized with a music signal S and then is output from the speaker unit 60 (S602).

If the level of the noise N input from the microphone unit 30 is determined to be lower than the level of the standard signal in the comparing circuit 18, the comparing circuit 18 outputs the control signal to the headphone amplifier 19 to instruct the operation thereof to be stopped (S603). Thus, the headphone amplifier 19 stops the output to the mixer 50.

Then, the comparing circuit 18 outputs the control signal to the DSP 15 to instruct the operation thereof to be stopped (S604). Upon receiving the control signal, the DSP 15 stops the process of generating the canceling signal for the input noise N.

Then, the comparing circuit 18 outputs the control signal to the muting circuit 22 (S605). As described above, with the control signal, the muting circuit 22 grounds the output terminal of the headphone amplifier 19. Thus, the NC 10a is electrically disconnected from the mixer 50 and the speaker unit 60.

As described above, in the case in which a level of a noise N is lower than a level of a standard signal, no noise canceling process is performed, an output from the headphone amplifier is stopped, and electrical disconnection is performed with the muting circuit 22. Thus, from the speaker unit 60, only a sound from a music signal S free of change in sound quality due to other signals (amplifier noise) and signal processing can be output from the speaker unit 60.

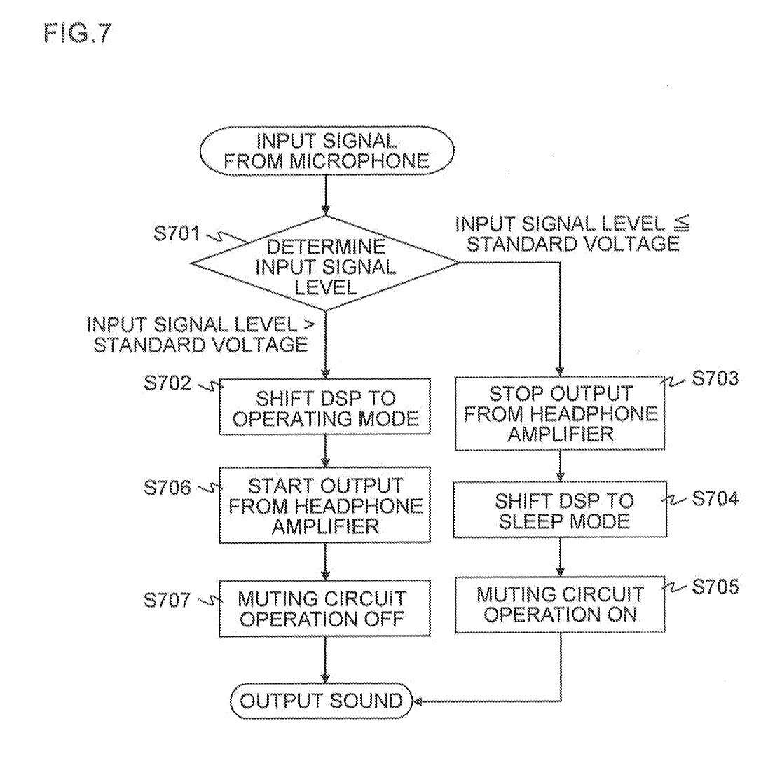

Another example of an operation of the NC 10a is described below with reference to a flowchart of FIG. 7. This embodiment depicts a flow of a process in which, with an output from the headphone amplifier stopped, the DSP shifted to a sleep mode, and the muting circuit in operation because a noise N input from the microphone amplifier 30 is equal to or smaller than the level of the standard signal, a noise N is further input from the microphone unit 30.

First, a noise N input from the microphone unit 30 amplified to a certain gain with the microphone amplifier 11 is input to the comparing circuit 18 so that the level of the noise N is compared with a level of a standard signal generated by the standard signal circuit 20 (S701).

If the level of the noise N input from the microphone unit 30 is determined to be lower than the level of the standard signal in the comparing circuit 18, as described above, with the control signals output from the comparing circuit 18: an output from the headphone amplifier 19 is stopped; the DSP 15 stops the canceling signal generating process; and the muting circuit 22 operates to ground the output terminal of the headphone amplifier 19 (S703, S704, and S705).

In the case in which a noise N of a level is higher than the level of the standard signal, the comparing circuit 18 outputs the control signal to the DSP 15 to instruct the operation for generating a noise canceling signal to be started (S702).

Then, the comparing circuit 18 outputs the control signal to the headphone amplifier 19 to instruct the operation thereof to be started (S706). Thus, the headphone amplifier 19 starts the output to the mixer 50. Then, the comparing circuit 18 stops outputting the control signal to the muting signal 22 (S707).

Thus, as described above, an output signal from the headphone amplifier 19 is fed to the mixer 50. Note that, by turning the operation of the muting circuit off after starting the output from the headphone amplifier, a noise generated at the start of the operation of the headphone amplifier can be prevented from being output to the mixer 50.

As described above, if the level of the noise N input after the noise canceling process has been stopped is higher than the level of the standard signal, the noise canceling process can be restarted. Further, the muting circuit allows an internal noise generated upon starting the output of the noise canceling signal to be prevented from being output. Therefore, only a sound from a sound signal S free of change in sound quality due to the signal process can be output.

As has been described above, the noise canceling headphone according to the present invention is used as a regular headphone and performs the noise canceling process only in the case in which an ambient noise is large. Thus, the change in sound quality peculiar to noise canceling headphones is reduced as much as possible so that music with high sound quality can be enjoyed for a long period of time with low battery consumption.

In the description of the embodiments, the NC 10 and the NC 10a perform canceling signal generation process with a digital signal processing using a DSP. The present invention is not limited thereto, and the same process can be performed with a noise canceling circuit formed of an analog circuit.

In this specification, the term “music signal” refers to a so called audio signal as well as to a music signal in general, and is also called a “sound signal”.

### INDUSTRIAL APPLICABILITY

The present invention can also be applied for a noise canceling process in various sound systems such as a car audio and that in a concert hall with which a music signal is reproduced and output.

1. A noise canceling headphone comprising: a microphone that converts a surrounding noise into an electrical signal; a canceling signal generating unit that generates a canceling signal by inverting a phase of a noise signal obtained by the conversion in the microphone; a speaker that mixes and outputs an audio signal and the canceling signal; a headphone amplifier that drives the speaker with the canceling signal; a standard signal generating unit that generates a standard signal of a certain level; and a comparing unit that outputs a control signal according to a result of comparing the noise signal with the standard signal, wherein
in a case in which the noise signal is smaller than the standard signal, with the control signal output from the comparing unit,
an operation of the headphone amplifier is stopped and then, a process of the canceling signal generating unit is stopped.

2. The noise canceling headphone according to claim 1 further comprising a muting unit that electrically disconnects the speaker unit from the headphone amplifier, wherein
the muting unit electrically disconnects the speaker unit from the headphone amplifier after the process of the canceling signal generating unit is stopped with the control signal.

3. A noise canceling headphone comprising: a microphone that converts a surrounding noise into an electrical signal; a canceling signal generating unit that generates a canceling signal by inverting a phase of a noise signal obtained by the conversion in the microphone; a speaker that mixes and outputs an audio signal and the canceling signal; a headphone amplifier that drives the speaker with the canceling signal; a standard signal generating unit that generates a standard signal of a certain level; and a comparing unit that outputs a control signal according to a result of comparing the noise signal with the standard signal, wherein
in a case in which the noise signal is larger than the standard signal, with the control signal output from the comparing unit,
a process of the canceling signal generating unit is started and then, an operation of the headphone amplifier is started.

4. The noise canceling headphone according to claim 3 further comprising a muting unit configured to electrically connect the speaker unit and the headphone amplifier, wherein
an operation of the muting unit is stopped after the operation of the headphone amplifier is started with the control signal to make the speaker unit and the headphone amplifier electrically connected.

5. The noise canceling headphone according to claim 1 further comprising a standard level adjusting unit that adjusts a generation level of the standard signal.

6. The noise canceling headphone according to claim 1, wherein the standard level adjusting unit can adjust a level of the standard signal in a plurality of steps.

7. The noise canceling headphone according to claim 1, wherein the standard level adjusting unit can adjust a level of the standard signal in a nonstep manner.
